(19) United States
(12) Patent Application Publication
(10) Pub. No.: US 2017/0002729 A1
(43) Pub. Date: Jan. 5, 2017

(54) Supercharging Arrangement

(71) Applicant: TOROTRAK (DEVELOPMENT) LTD, Lancashire (GB)

(72) Inventor: David Burtt, Lancashire (GB)

(73) Assignee: Torotrak (Development) LTD, Lancashire (GB)

(21) Appl. No.: 15/100,177

(22) PCT Filed: Dec. 1, 2014
(86) PCT No.: PCT/EP2014/076078

§ 371 Date: May 27, 2016

(30) Foreign Application Priority Data
Nov. 29, 2013 (GB) 1321152.9

(51) Int. Cl. F02B 39/04; F04D 25/16; F02B 33/40

(52) U.S. Cl. CPC F02B 39/04; F02B 33/40; F04D 25/163

(57) ABSTRACT

A supercharging arrangement for an internal combustion engine is disclosed. The supercharging arrangement has a supercharger having a rotational drive input. A transmission having a rotational drive input receives drive from an internal combustion engine, and a transmits drive to a rotational drive output connected to the input of the supercharger.

The transmission includes a continuously-variable transmission means, such as a toroidal variator, operatively connected between the input and the output of the transmission. The supercharger comprises first and second compressors connected in series within an air path.

The present invention relates to a supercharging arrangement for an internal combustion engine. In particular, it relates to a compressor arrangement for a supercharger in which drive is transmitted from an internal combustion engine to a supercharger through a drive system that includes a continuously-variable transmission (CVT).

The invention has particular application to passenger cars and light road vehicles, but might also be applied to heavy road vehicles. Whilst this is not the only application of the invention, this application will be used as a basis for description of how the invention might be implemented. In this regard, embodiments of the invention will typically be used on an engine that is controlled by a driver using a foot pedal that allows a driver to control the amount of torque that the engine will cause to be delivered to the vehicle's transmission. In the case of a petrol engine, this pedal will directly or indirectly control the position of a throttle that regulates flow of air into the engine, while in the case of a diesel engine, the pedal will directly or indirectly control the amount of fuel that will be injected into the engine. Therefore, in this specification, the commonly-used term “accelerator pedal” will be used to refer generally to such a pedal independently of its actual, physical effect on the operation of the engine.

Forced induction is seen as making an important contribution to improving the efficiency of internal combustion engines. In particular, superchargers driven mechanically from the engine (as contrasted with exhaust-driven turbochargers) can offer a considerable degree of control over the amount of air entering the engine at any given time. In general, the rotational speed at which a supercharger centrifugal compressor must be driven is greater than the rotational speed of the crankshaft of the engine by a large factor. For example, a typical petrol engine for a passenger car will operate at speeds between 750 and 6000 rpm, while a centrifugal supercharger compressor might be required to operate at between 40 000 and 250 000 rpm. Hitherto, this has typically been achieved by providing a step-up gear train of fixed ratio between the crankshaft and the supercharger centrifugal compressor.

In the case of a positive-displacement supercharger, the compressor speeds are typically in the range 3000 rpm to 24000 rpm for comparable engine speeds.

It is apparent that causing the supercharger to be driven at a fixed multiple of the crankshaft speed is not optimal. When the driver requires high torque at a low engine speed then increased air flow is beneficial. Conversely, when the driver requires an amount of torque from the engine that can be obtained without supercharging, energy delivered to the supercharger is wasted. It is clear that providing a variable-ratio drive between the crankshaft and the supercharger could be used to increase engine torque at low engine speeds whilst reducing the amount of wasted energy, and that a continuously-variable ratio drive has clear advantages over a fixed ratio drive.

Superchargers commonly employ a dynamic compressor, most typically in the form of a centrifugal compressor. The characteristics of a centrifugal compressor are such that it is not possible to deliver high pressure ratios at low engine speeds whilst also achieving sufficient air mass flow to satisfy an engine at higher operating speed in an automotive application. It is also difficult to achieve sufficient pressure ratio to satisfy advanced combustion cycles for example gasoline direct injection compression ignition (GDCI), over a substantial engine speed range with a fixed ratio supercharger consisting of a single compressor.

### SUMMARY OF THE INVENTION

From a first aspect this invention provides a supercharging arrangement for an internal combustion engine comprising: a supercharger having a rotational drive input; a transmission having a rotational drive input to receive drive from an internal combustion engine, and a rotational drive output connected to the input of the supercharger; the transmission including a continuously variable transmission means operatively connected between the input and the output of the transmission, wherein the supercharger includes first and second compressors connected in series.

In this context, “in series” means in series within an air path, whereby air output from one compressor is received at an air input of the other compressor.

Most typically, the compressors will be dynamic compressors, and more specifically, centrifugal compressors. However, one or both compressors may have an alternative configuration, such as that of an axial compressor.

Embodiments of the invention provide first and second dynamic compressors connected in series, such as to enable a mode of operation which avoids surge conditions, which surge conditions would be created by using a single stage of compression for example a centrifugal compressor.

The use of a variable speed drive may advantageously be combined with two (or more than two) dynamic compressors connected in series, in accordance with the invention to aim to provide the following benefits:
High pressure ratio at low engine speed.
Higher pressure ratios at lower compressor speeds, enabling a lower overall step-up ratio within the supercharger arrangement
High pressure ratio across the complete engine speed range.
Improved overall compression efficiency due to moving each individual compressor into a more efficient operating condition.
Reduced compressor speeds resulting in lower losses in the supercharger arrangement

The supercharging operating envelope thus achieved may be superior to any dynamic compressor consisting of a single stage of compression, for example a centrifugal compressor currently available. The use of variable speed drive superchargers on downsized automobile engines, and the use of two dynamic compressors connected in series addresses some very specific problems that arise with dynamic superchargers, as will become apparent below.

The first and second compressors may be identical, or more preferably each may be individually optimised as befits their purpose. The compressors may be coupled in series as separate units, or, for a more compact configuration, they may be in a common housing, for example, coupled in a back to back configuration. The compressors may be driven from the continuously-variable transmission from a common drive shaft, or may be coupled to a drive so as to operate at different speeds, and hence have different operating characteristics, so as to produce different compressions. In order to produce optimal compression, the first compressor may be configured differently to the second.. The second compressor may be ‘smaller’ than the first. By this, it is understood that the second compressor may be physically smaller than the first, it may have an outer diameter that is less than that of the first, or it may produce a lower pressure ratio at a given speed than compared with the first compressor.

Cooling arrangements may be provided in the air path. The cooling arrangements may be after the second compressor, in order to keep air temperature low for the combustion process. Alternatively or additionally, cooling arrangements may be provided between the first and second compressors, to ensure a more optimal compression in the second stage. Cooling arrangements may include convection by mechanical fins on the compressor housings, air-to-air, air-to-oil or air-to-water heat exchangers (radiators), or a water-cooled compressor housing.

For light vehicle internal combustion engines, the supercharger input/output pressure ratio is suitably less than 2, though this value may be higher for downsized engines, for example from in excess of 2 to 6. The provision of serial compressors gives the opportunity for each individual compressor to operate at a much lower pressure ratio, and hence produces advantages in avoiding surge effects, as will become apparent below. Typically, diesel heavy vehicles conventionally operate at pressure ratios approaching 3, however future requirements may increase this required overall pressure ratio to a considerably higher value of between 3 and 7. Under these conditions, a variable speed drive supercharger including two compressors in series may advantageously be combined with conventional turbocharger systems.

In typical embodiments, the continuously variable transmission means includes a toroidal variator. Embodiments may employ various configurations of toroidal variator, including a half toroidal variator or a full toroidal variator. Further embodiments may use other types of variator, including belt-and-pulley systems, ball-bearing or ball-and-ring variators.

In a preferred embodiment, the variator has:
an input surface and an output surface, the input and output surfaces being coaxially mounted for rotation about a variator axis, and a toroidal cavity being defined between the working surfaces;
at least one rolling element disposed between and being in driving engagement through a traction fluid with the input and the output surfaces at respective contact regions, each rolling element being mounted on a carriage assembly for rotation about a rolling axis, each rolling element being free to pivot about a tilt axis, the tilt axis passing through the rolling element perpendicular to the rolling axis, and intersecting the rolling axis at a roller centre, whereby a change in the tilt angle occurs with a change in the variator ratio being the ratio of rotational speeds of the races; wherein
the or each carriage assembly can cause pivotal movement, which pivotal movement about a pitch axis that results in a change of a pitch angle of the rolling element, the pitch axis passing through the roller centre and through the contact regions; and
the variator further including a control member operative to cause at least one carriage assembly to undertake the pivotal movement thereby changing the pitch angle, so urging the plurality of rolling elements to pivot about their tilt axes and thereby provide a change in variator ratio.

Preferably, each carriage assembly is mounted for pivotal movement about a pitch axis passing through the centre of the respective rolling element and is actuated at an actuation point radially distant from the axis such that the carriage pivots about the said pitch axis. Suitably, each carriage is constrained to precess about a castor axis which is inclined to the plane of the races such that the carriage pitch input causes the rolling elements to be steered by the races to a new equilibrium tilt angle commensurate with a new variator ratio. Preferably each actuation point is offset from the centre plane of the toroidal cavity in a direction parallel to the variator axis. The castor axis for each rolling element preferably extends through the centre of the rolling element and its actuation point.

In a further preferred embodiment, each carriage assembly is constrained to the pivotal movement by i) coupling with the control member about an actuation point and ii) coupling about a reaction point which acts on the centre of rotation of the rolling element or at a point between the centre and the actuation point for bearing torque from the rolling elements.

Each rolling element and its respective carriage assembly together suitably have four points of contact, the points of contact being at the input surface, the output surface, an actuation point and a reaction point, such that the rolling element is constrained in its position in the toroidal cavity.

The control member in the preferred variator is preferably adapted to provide actuation by translational movement.

Preferably the carriages are actuated one side of a plane that includes the variator axis.

In the preferred variator, the control member actuates the carriage assembly at a location radially outward of a cylindrical surface that has an axis substantially coincident with the variator axis and tangential to the periphery of the larger of the input surface and output surface. Suitably, the respective carriage assemblies are actuated simultaneously. Each respective carriage assembly may have its own actuator.

In a preferred embodiment, the variator has a single control member on which the carriage assemblies are mounted.

In a further preferred embodiment, the variator additionally comprises:
a second input surface and a second output surface that faces the second input surface to define a second toroidal cavity;
a second plurality of rolling elements disposed between the second input and second output surfaces and being in driving engagement with the surfaces, each rolling element being rotatably mounted on its respective carriage assembly and able to tilt about an axis passing through the centre of the rolling element, whereby a change in the tilt angle causes a change in variator ratio,
a carriage assembly can cause pivotal movement, which pivotal movement about a pitch axis that results in a change of a pitch angle of the rolling element, the pitch axis passing through the rolling element centre and through the contact regions; and
the control member or a second control member operative to cause the or each carriage assembly of the second cavity to undertake the pivotal movement thereby changing the pitch angle, so urging the plurality of rolling elements to pivot about their tilt axes and thereby provide a change in variator ratio.

The variator may include:
a first reaction member operatively coupled to the plurality of rolling elements in the first cavity and a second reaction member operatively coupled to the second plurality of rolling elements in the second cavity such that the first and second reaction members bear reaction loads arising from the respective rolling elements; and
a load-sharing assembly operatively linked to the reaction members of the first and second cavities such that reaction torque from the reaction members is balanced.

### BRIEF DESCRIPTION OF THE DRAWINGS

Embodiments of the invention will now be described in detail, by way of example, and with reference to the accompanying drawings, in which:

FIG. 1 is a compressor flow map for use in illustrating the operation of embodiments of the invention as compared with prior art arrangements;

FIG. 2 is a graph of engine speed v. air pressure at the inlet manifold of an engine, for a known arrangement of a supercharger with a single stage of compression for example a centrifugal compressor;

FIG. 3 is a graph of engine speed v. air pressure at the inlet manifold of an engine, for an arrangement of a supercharger with two centrifugal compressors connected in series, in accordance with the invention;

FIG. 4 is a sectional schematic view of a first embodiment of the invention including two centrifugal compressors connected in series;

FIG. 5 is a sectional schematic view of a second embodiment of the invention including two centrifugal compressors connected in series; and

FIG. 6 is a schematic diagram of a supercharging arrangement for an internal combustion engine that embodies the invention.

### DETAILED DESCRIPTION OF THE EMBODIMENTS

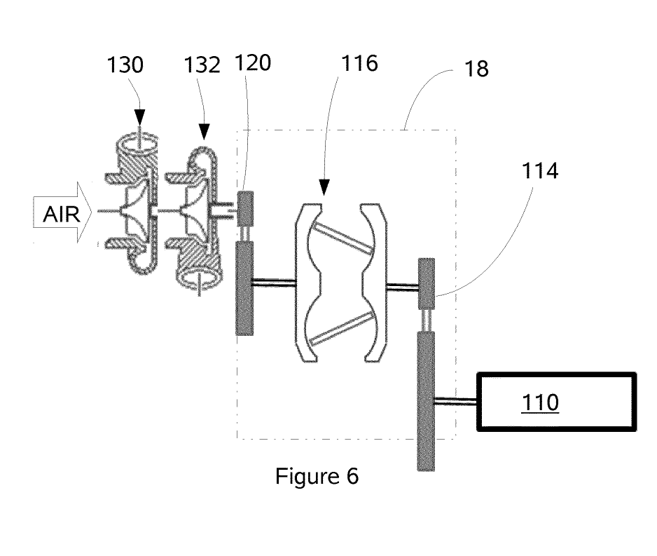

Referring to FIG. 6, this shows a supercharging arrangement for an internal combustion engine 110, wherein the engine 110, is coupled to a transmission 18 for the supercharger. The transmission has a belt drive 114 with a ratio of output rotational speed to input rotational speed typically of 3:1. The output of the belt drive is coupled to a continuously variable transmission (CVT) 116 that includes a toroidal variator having a rotational speed ratio of output to input of typically between 0.4 to 2.5:1. The output of the CVT 116 is coupled to a traction epicyclic 120 of typical rotational step-up speed ratio about 12:1 to give a typical final output ratio at the drive input of the supercharger of about 90:1. (This step-up ratio is shown as a simple gear for clarity in FIG. 6). Thus for an engine speed of for example 1000 rpm, the compressor(s) of the supercharger will be driven at 90,000 rpm. As shown, the supercharger includes first and second centrifugal compressors 130, 132 connected in series such that the output of the first compressor 130 is delivered to the input of the second compressor 132.

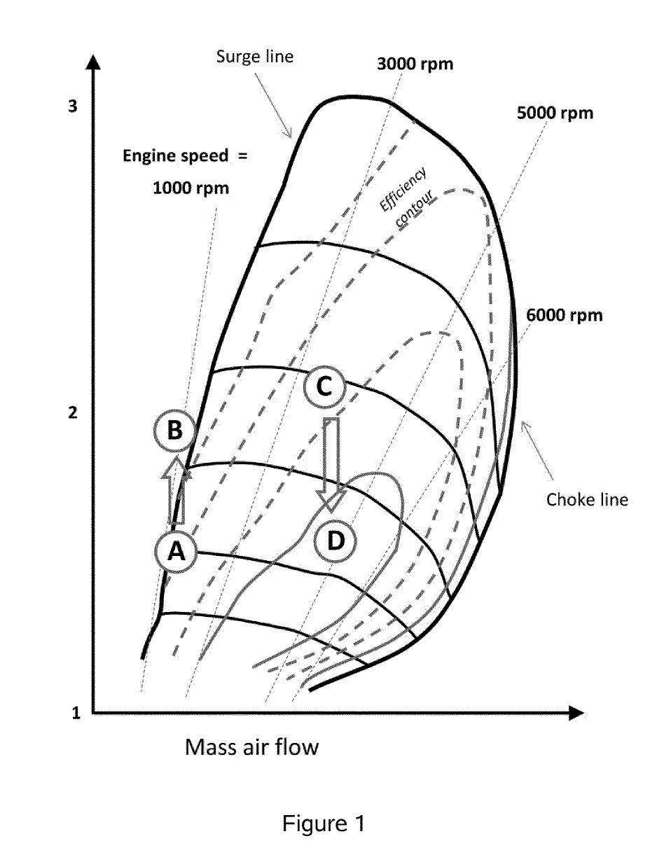

Referring to FIG. 1, this is a compressor flow map for a single-stage compressor used in a supercharger, with air mass flow in kg/s on the x-axis, and outlet/inlet pressure ratio on the y-axis. The central area represents the region of compressor operation. Contours within this region indicate efficiency of compressor operation:

thick lines extending generally from left to right indicate operation of the compressor at constant rotational speeds, and straight generally vertical lines are “load lines” for various engine speeds for the arrangement of FIG. 6, indicating where the compressor may operate for a given engine speed. The grey contours indicate points of equal compressor efficiency, with the highest efficiencies being achieved in the central and lower regions of the map. Of interest is the right-hand boundary of the map, which indicates the “choke condition”, in which additional air mass cannot physically be pushed through the compressor, and the left-hand boundary, known as the “surge line”. At the surge line, the compressor cannot admit enough air at the inlet for correct operation, and malfunctions will occur, with air being forced back out of the compressor inlet, resulting in pressure shock waves that could possibly cause mechanical damage. A single centrifugal compressor may be adjusted so that so that the area of operation, as indicated by the map, may be translated to the left or right of FIG. 1, but it is not easily possible to expand the area of operation by moving apart the surge line and the choke condition boundaries.

Of interest in the present invention is operation at low engine speeds and high pressure ratio. It may be seen that for engine speed of 1500 rpm or less, for example substantially less than 1500 rpm, operation of the compressor is not possible, since operation is required to the left of the surge line: an impossible condition. However this is an area where it is beneficial to operate downsized engines with supercharging arrangements.

Consider the example of a single centrifugal compressor with a single stage of compression, for example a single centrifugal compressor and a mid-range engine speed delivering a pressure ratio of 2.2. Consider a mid-range operation at point C in FIG. 1 at engine ˜3000rpm, compressor speed 140 000 rpm, with a required pressure ratio of 2.2, mass air flow (MAF) of 0.063 kg/s and a compressor efficiency of 0.64. It can be shown that the power required to drive the compressor is about 6 kW.

If we now do this in two stages of compression, for example with two centrifugal compressors connected in series, the pressure ratio in each stage is 1.48 (√2.2). As indicated by point D, compressor speed is 100 000 rpm, note an improved compressor efficiency of 0.74 having kept the same MAF of 0.063 kg/s, so the power required per stage of compression is about 2.5 kW which, when doubled yields 5 kW total power required.

At point D, compressor efficiency is 0.74, as opposed to point C which is 0.64, so that overall there is an improvement in compression efficiency with a two-stage compression arrangement achieved at a lower compressor speed. This can reduce speed dependent power losses thus leading to an overall efficiency improvement, which can be beneficial in regaining any losses incurred by use of a CVT.

A second example, once again idealised, is to consider what boost is achievable at 1000 engine rpm. At this engine speed, the compressor speed is necessarily limited by the maximum step-up ratio available (approximately 90 in FIG. 6). At a physically limited compressor speed of about 90 000 rpm the maximum pressure ratio achieved is approximately 1.5, which is some way short of the target pressure ratio of approximately 2. At this condition, it is also possible that the compressor will be operating in mild surge.

By adding a second compressor in series it is possible to utilise two pressure ratios in series, hence 1.5×1.5=2.25 for the same speed-limited compressor speed. A further benefit now is that a higher air mass flow rate is required to achieve the higher pressure ratio, so the operating point moves to the right on the compressor map for increased mass air flow, thus moving to a condition of improved compressor efficiency and less serious, or with complete avoidance of, surge conditions. Hence, this example effectively increases the width of the compressor map at low engine speeds without sacrificing air delivery at high engine speeds, thereby creating an extra degree of flexibility in the application of compressors to downsized engines by using a variable-speed drive.

Referring to the compressor map of FIG. 1, consider the example of engine speed of 1000 rpm and typical maximum ratio from engine to compressor of 90:1. This results in a compressor speed of 90000 rpm and a maximum pressure ratio of ˜1.42 (point A). Using two compressors in series, this pressure ratio can be approximately squared to ˜2.0 (point B) thus permitting an operating condition that is not possible with a single compressor.

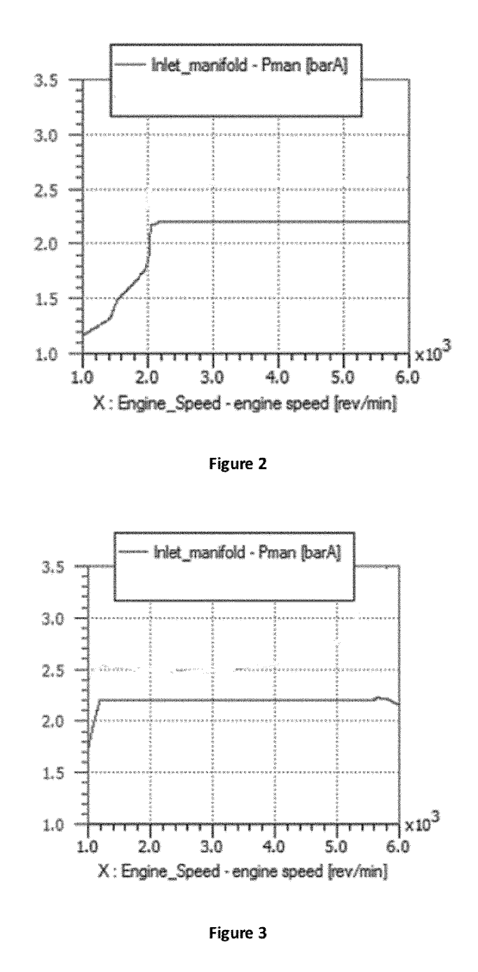

FIG. 2 illustrates the pressure achievable at an inlet manifold for a single centrifugal compressor arrangement. It will be noted manifold pressure reduces rapidly at low engine speed below 2000 rpm. This arises from interaction with the compressor map surge line; that is to say, the compressor is nearing or experiencing surge.

FIG. 3 illustrates the pressure achievable at an inlet manifold for an arrangement comprising two centrifugal compressors in series. It will be noted that high manifold pressure is maintained at low engine speeds, and that operation of the compressor is possible with engine speeds approaching 1000 rpm by removing the interaction with the compressor map surge lines of each individual compressor, such that the compressor is not nearing a condition in which surge will occur.

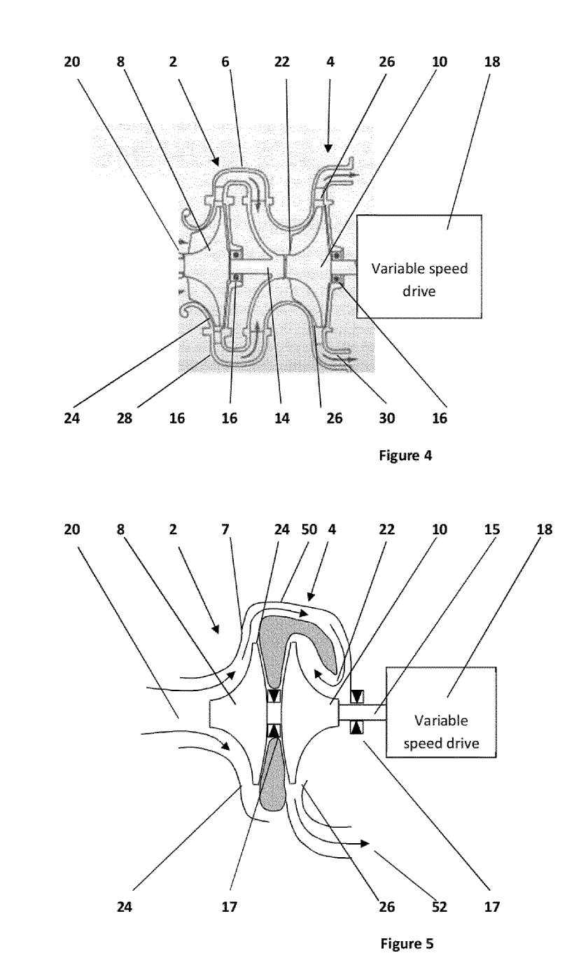

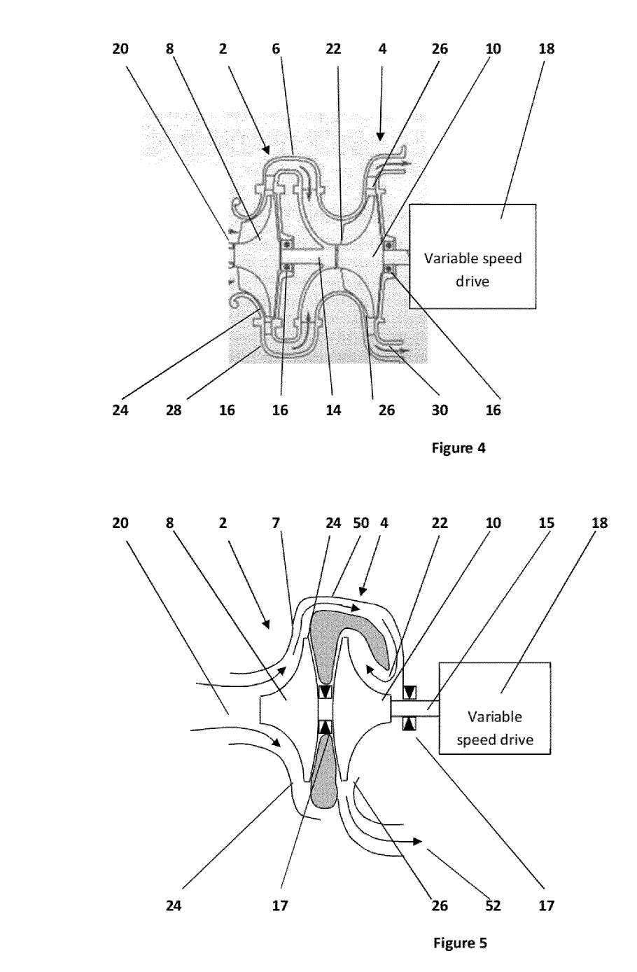

Referring to FIG. 4, this shows a first embodiment of first and second centrifugal compressors 2, 4 connected in series, where the air output of the first compressor 2 is directly mechanically coupled to the air input of the second compressor 4. A casing 6 surrounds the compressors and defines air flow paths. Impellers 8, 10 of the compressors are mounted on a common drive shaft 14, which is suspended along its length by bearings 16. The drive shaft 14 is driven by a variable speed drive 18, as indicated in FIG. 6. In this embodiment, because of the length of the drive shaft between the two compressors and a resulting cantilever effect, high speed bearings may be required. It may be seen that each impeller 8, 10 tapers from a relatively small diameter at an inlet side 20, 22 of the compressor, to a large diameter at the outlet side of the compressor 24, 26, in the general form of a trumpet. The casing 6 provides an airflow path 28 from outlet 24 to inlet 22, and an outlet path 30 from outlet 26.

FIG. 5 shows a second embodiment of two centrifugal compressors connected in series, where similar parts to those of FIG. 4 are denoted by the same reference numeral. The compressors 2, 4 are mounted in a “back-to-back” configuration to arrive at a more compact structure that is capable of being supported solely by the traction epicyclic subsystem (or alternative step-up ratio arrangement such as a gear set, belt/pulley or chain/sprocket) of the variable speed drive unit, thereby avoiding the need for high speed bearings. A casing 7 surrounds the compressors and defines air flow paths. Impellers 8, 10 of the compressors are mounted on a common drive shaft 15, which is contacted along its length by seals 17. The drive shaft 15 is driven by a variable-speed drive 18. In this embodiment, because of the shortened length of the drive shaft 15 as compared with that of FIG. 4, high-speed bearings may not be required. It may be seen that each impeller 8, 10 tapers from a relatively small diameter at an inlet side 20, 22 of the compressor, to a large diameter at the outlet side of the compressor 24, 26, The casing 7 provides a convoluted airflow path 50 from the outlet 24 of the first compressor to the inlet 22 of the second compressor, and an outlet path 52 from the outlet 26 of the second compressor.

The embodiment of FIG. 5 may be modified by actually joining the compressors back-to-back (that is, with both back faces touching) thereby eliminating the requirement for a seal between the compressors and bearings 17.

Thus, the present invention may offer the following benefits. Firstly, avoiding the surge line to allow operation in a previously unachievable area, and secondly allowing an operating condition to be achieved at lower compressor speed and higher efficiency. Lower speed may be particularly appealing if, for example, the variable speed supercharger arrangement has ratio limitations, or its efficiency is non-uniform throughout its operating range, or there are specific speed-related losses. It may be possible to opt for step-up ratios between crank and compressors that are reduced greatly, for example, where moderate overall pressure ratios are required. For example, the final step-up ratio provided by the supercharger arrangement, conventionally achieved using a traction epicyclic, may be reduced to less than 12, less than 8 or even less than 4. The traction epicyclic may therefore be substituted by a conventional epicyclic, by a meshing gear set or by a belt/pulley or chain/sprocket system.

1. A supercharging arrangement for an internal combustion engine comprising:
a supercharger having a rotational drive input;
a transmission having a rotational drive input to receive drive from an internal combustion engine, and a rotational drive output connected to the input of the supercharger;
the transmission including a continuously variable transmission operatively connected between the input and the output of the transmission,
wherein the supercharger comprises first and second compressors connected in series within an air path.

2. (canceled)

3. (canceled)

4. (canceled)

5. (canceled)

6. (canceled)

7. A supercharging arrangement according to claim 1 wherein at least one of the first and the second compressors is a dynamic compressor.

8. A supercharging arrangement according to claim 7 wherein both of the first and the second compressors are dynamic compressors.

9. A supercharging arrangement according to claim 8 wherein both of the first and the second compressors are centrifugal compressors.

10. A supercharging arrangement according to claim 9, wherein each compressor comprises an impeller which tapers radially outwardly from a relatively small inlet side to a relatively large outlet side, wherein the outlet sides of the impellers of the first and second compressors are disposed adjacent one another in a back-to-back configuration, and an outer casing of the compressors is configured to provide appropriate inlet and outlet fluid flow paths to the compressors.

11. A supercharging arrangement according to claim 7 wherein the second compressor is physically smaller than the first compressor.

12. A supercharging arrangement according to claim 7 wherein the outer diameter of the second compressor is smaller than that of the first compressor.

13. A supercharging arrangement according to claim 7 wherein the pressure ratio generated by the second compressor is smaller than that of the first compressor at a given supercharger input speed.

14. (canceled)

15. A supercharging arrangement according to claim 7 wherein the first and second compressors are arranged in a back-to-back configuration.

16. A supercharging arrangement according to claim 7 wherein the supercharger comprises the first and second compressors connected in series, such as to enable a mode of operation which avoids surge conditions, which surge conditions would be created by a single compressor.

17. A supercharging arrangement according to claim 1, wherein the first and second compressors are mounted on a common drive shaft, driven from a common or single output from a variable speed drive or CVT and such compressors operate to increase pressure in a serial manner.

18. A supercharging arrangement according to claim 17 wherein the common drive shaft is supported by first and second bearings disposed along the length of the drive shaft.

19. A supercharging arrangement according to claim 1, wherein the first and second compressors are each configured to provide different input/output pressure ratios from each other.

20. A supercharging arrangement according to claim 1, including a cooling arrangement for cooling air, disposed between the first and second compressors.

21. A supercharging arrangement according to claim 1, including a cooling arrangement for cooling air, coupled to the outlet of the second compressor.

22. (canceled)

23. A supercharging arrangement according to claim 1, intended for a light road vehicle, wherein the supercharger input/output pressure ratio is less than, or about, 2.

24. A supercharging arrangement according to claim 1, intended for a heavy road vehicle with diesel engine, and wherein the supercharger input/ output pressure ratio is between 2 and 4.

25. (canceled)

26. (canceled)

27. (canceled)

28. (canceled)

29. (canceled)

30. (canceled)

31. (canceled)

32. A supercharging arrangement according to claim 1 wherein the first and second compressors are driven from the continuously-variable transmission by a common shaft.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. A supercharging arrangement according to claim 1 wherein the continuously-variable transmission includes a variator and control system operative to set the operating ratio of the variator, and wherein the control system operates to cause the internal combustion engine to deliver an amount of torque that is indicated by the state of an input to the control system, and wherein the control system is operative to calculate a target value of a control variable that is representative of the instantaneous state of operation of the internal combustion engine associated with the supercharging arrangement.

48. A supercharging arrangement according to claim 47, wherein the control system is operative to calculate a target variator ratio such that the speed at which the supercharger operates approaches that to achieve the value of the control variable.

49. A supercharging arrangement according to claim 47, wherein the control system is operative to adjust the variator ratio to ensure that the rate at which the supercharger speed changes does not exceed a predetermined limit.

50. A supercharging arrangement according to claim 49, wherein the predetermined limit is one or more of a proportion of the total engine torque or a fixed maximum value.
